(19) United States
(12) Patent Application Publication
(10) Pub. No.: US 2012/0063491 A1
(43) Pub. Date: Mar. 15, 2012

(54) SPREAD SPECTRUM SIGNAL RECEIVER, METHOD FOR MULTIPATH SUPER-RESOLUTION THEREOF, AND RECORDING MEDIUM THEREOF

(75) Inventors: Seung-Hyun Kong, Daejeon (KR); Wooseok Nam, Busan (KR)

(73) Assignee: KOREA ADVANCED INSTITUTE OF SCIENCE AND TECHNOLOGY, Daejeon (KR)

(21) Appl. No.: 13/228,007

(22) Filed: Sep. 8, 2011

(30) Foreign Application Priority Data
Sep. 13, 2010 (KR) 10-2010-0089430

(51) Int. Cl. H04B 1/7115

(52) U.S. Cl. 375/148; 375/E01.032

(57) ABSTRACT

A spread-spectrum signal receiver, a multipath signal super-resolution method thereof, and a recording medium thereof are disclosed. Using a least-squares based iterative multipath super-resolution (LIMS) algorithm, the spread-spectrum signal receiver accurately resolves multipath signals in a multipath channel environment so as to extract necessary information such that a rake receiver tracks the multipath signals more accurately. Since the LIMS technique has high resistance against noise and require less computation, it may be used to resolve the multipath signals in real time and to extract a first arrival path signal of a first arrival signal and may be easily implemented offline.

### CROSS-REFERENCE TO RELATED APPLICATION

This application claims priority to Korean Patent Application No. 10-2010-0089430, filed on Sep. 13, 2010, and all the benefits accruing therefrom under 35 U.S.C. §119, the contents of which in its entirety are herein incorporated by reference.

### TECHNICAL FIELD

The present disclosure relates to multichannel component resolution technology in a multipath channel environment in which a plurality of multipath signals are received, and, more particularly, to a spread-spectrum signal receiver, a multipath signal super-resolution method thereof, and a recording medium thereof.

### BACKGROUND

Recently, a position measurement system such as a Global Positioning System (GPS) or a Global Navigation Satellite System (GNSS) has been utilized not only in aircraft navigation but also in personal and vehicle navigation. In an aircraft transmission environment, a line-of-sight (LOS) signal component is always transmitted from a GPS satellite to a receiver without interruption, and multipath signal components reflected from the ground can be received. However, the intensities of the multipath signal components in the aircraft transmission environment are significantly weaker than that of the LOS signal component. Since time delays of the multipath signal components are large, the multipath components are easily distinguished from the LOS signal component.

However, since the downtown area has a multipath channel environment in which a transmitted signal reaches a receiver after being reflected and diffused by various geographical features such as buildings, the receiver receives a complex signal in which a plurality of multipath signals having different paths are mixed. Most of the city areas, in particular, the downtown area or indoors space, have a multipath channel environment. In general, among multipath signals having various time delays, which are received in the multipath channel environment, a minimum delay path signal having a minimum temporal delay is an LOS signal or a signal temporally closest to the LOS signal. Since the signal having the minimum temporal delay is a first arrival path signal, Time of Arrival (TOA) between the GPS satellite and the receiver is measured from the first arrival path signal so as to extract a most accurate pseudorange. The receiver detects the first arrival path signal from the received complex signal, obtains a most accurate pseudorange, and utilizes the pseudorange for position measurement.

However, since several multipath signals which are temporally close to each other, i.e., short-delay multipath signals, are mixed in the complex signal, the complex signal may be recognized as one first arrival path signal. In such an environment, not only mutual distance measurement accuracy using the TOA of the signal but also performance of a rake receiver which performs tracking of each signal component may be extremely decreased. As a result, it is difficult to extract the first arrival path signal using a signal processing algorithm of a receiver of the related art.

Recently, a novel first arrival path signal detection technology using a narrow correlator, which has an improved first arrival path signal extraction function compared with a wide correlator of the related art, has been developed. However, even in this technology, improved performance is not obtained for a plurality of short-delay multipath signals, which are temporally close to each other, included in the complex signal. In the case where the first arrival path signal is very weak, a significant pseudorange error occurs.

In addition to the narrow correlator, signal super-resolution algorithms for extracting a first arrival path signal, such as Multiple Signal Classification (MUSIC), estimation of signal parameters via rotational invariant techniques (ESPRIT), a matrix pencil technique or Finite Rate of Innovation (FRI) developed in the 2000 s, have been developed. Since all the signal super-resolution algorithms which have been developed to date are weak against noise, if the intensity of noise is high or the intensity of the signal is low, performance of these algorithms deteriorates extremely. In some cases, the performance of these algorithms is inferior to that of the narrow correlator. In addition, the signal super-resolution algorithms such as MUSIC, ESPRIT, the matrix pencil technique and the FRI require considerable computation.

Accordingly, the signal super-resolution algorithms of the related art are associated with high sampling frequency, considerable computation, and weakness against noise.

### SUMMARY

The present disclosure is directed to providing a spread-spectrum receiver which is capable of solving problems of signal super-resolution algorithms of the related art in a multipath channel environment, improving distance and position measurement accuracy, and improving performance of a rake receiver.

The present disclosure is also directed to providing a multipath signal super-resolution method applied to the spread-spectrum signal receiver.

The present disclosure is also directed to providing a computer-readable recording medium, on which a program for executing a multipath signal super-resolution method of a spread-spectrum receiver in a computer system is recorded.

In one aspect, there is provided a spread-spectrum signal receiver including: a wide band-limited filter configured to pass only a predetermined band of a spread-spectrum signal; an analog-to-digital converter configured to convert the spread-spectrum signal passing through the wide band-limited filter into a digital signal; a correlator bank configured to receive the digital signal, to perform correlation with respect to a plurality of code phases distributed in a plurality of chip periods, and to generate input data; and a computing unit configured to compute a complex amplitude vector and Time of Arrival (TOA) vector with respect to a predetermined number of multipath signals using the input data for each iteration order, to compute the iterative estimation error value from the complex amplitude vector and the TOA vector, and to extract a complex amplitude vector and a TOA vector of the case where the iterative estimation error value computed for each iteration order is minimized.

In another aspect, there is provided a multipath signal super-resolution method of a spread-spectrum signal receiver, including: computing a complex amplitude vector and Time of Arrival (TOA) vector with respect to a predetermined number of multipath signals for each iteration order until an iterative estimation error value becomes equal to or less than a threshold and computing the iterative estimation error value from the complex amplitude vector and the TOA vector; and extracting a complex amplitude vector and a TOA vector of the case where the iterative estimation error value computed for each iteration order is minimized.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1a is a diagram showing a correlator output result of a complex signal including a multipath signal observed in a receiver;

FIG. 1b is a diagram showing an example of generating input data applied to an embodiment as the correlator output result sample of FIG. 1a;

FIG. 2 is a flowchart illustrating a least-squares based iterative multipath super-resolution (LIMS) algorithm according to an embodiment;

FIG. 3 is a detailed flowchart of FIG. 2;

FIG. 4 is a schematic block diagram of a spread-spectrum receiver according to an embodiment;

FIG. 5a is a diagram showing an embodiment in which a signal searcher 515 is added to FIG. 4;

FIG. 5b is a structural diagram of the signal searcher 515 used in FIG. 5a;

FIG. 6 is a block diagram of a spread-spectrum receiver according to another embodiment;

FIG. 7 is a diagram showing an embodiment in which a snapshot 730 is added to FIG. 6;

FIG. 8 is a block diagram of a spread-spectrum receiver according to another embodiment; and

FIG. 9 is a diagram showing an embodiment in which a snapshot 930 is added to FIG. 8.

### DETAILED DESCRIPTION

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

Embodiments of the disclosure propose a configuration for detecting a first arrival path signal from multipath signal components in a receiver for measuring Time of Arrival (TOA) of spread-spectrum signals and computing a distance between a transmitter and a receiver (e.g., a distance between a GPS satellite and a receiver) using the TOA. Specifically, the embodiments use a least-squares based iterative multipath super-resolution (LIMS) algorithm.

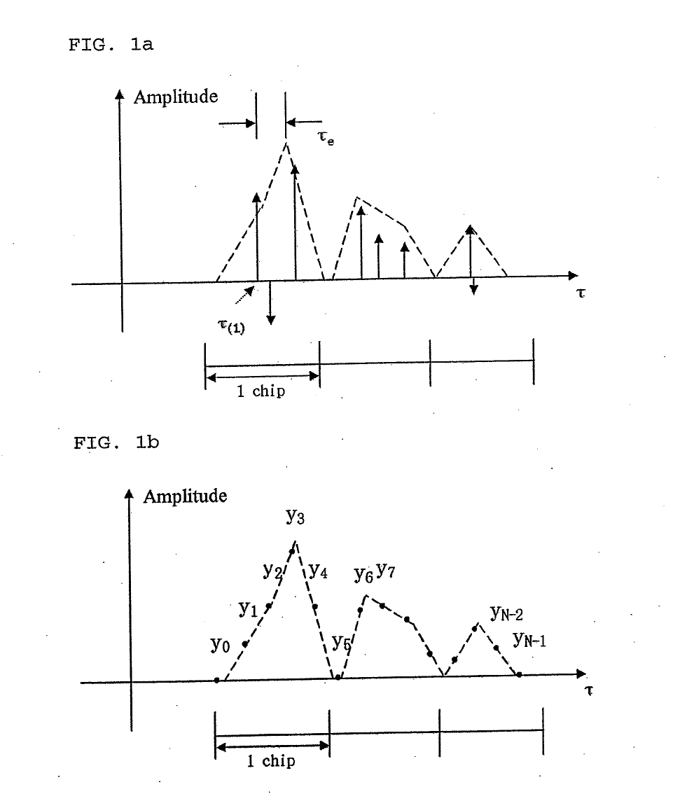

FIG. 1a shows a TOA delay τ of each of received multipath signal and an amplitude thereof using arrows (a start position of each arrow denotes the TOA delay and the length of each arrow denotes the intensity of the signal).

In FIG. 1a, the shape of the received multipath signals finally observed in a baseband of the receiver through a correlation function of the receiver is denoted by a dotted line. The TOA delay refers to an excess delay obtained by subtracting the TOA of a line-of-sight (LOS) signal component from the TOA of the multipath signals. As shown, the receiver does not accurately detect the first arrival path signal having a minimum TOA τ₍₁₎ from eight multipath signals but recognizes a local peak of the dotted line as the TOA of the first arrival path signal. If the TOA is obtained from a first peak of a distortion signal component instead of a peak of the correlation result of an actual signal, a TOA measurement error τₑ occurs.

The TOA measurement error may occur due to various causes. In general, an error may occur when the intensity of the first arrival path signal is greatly attenuated and a signal having a relatively high intensity arrives just after the first arrival path signal (within one chip). In this case, the wide correlator and the narrow correlator of the related art have the measurement error τₑ as shown in FIG. 1.

FIG. 1b shows a process of generating input data Y from a correlation function output (dotted line) of FIG. 1a.

While the dotted line of FIG. 1a denotes a continuous function in a time axis, an actual input baseband signal includes sample outputs of points as shown in FIG. 1b. That is, the received signal is converted into digital samples and the digital samples are input to a correlation function in real time, thereby obtaining correlation function outputs (points of FIG. 1b) having a constant interval. The receiver determines that the correlation function output is not noise but an actually received signal component, if the amplitude of the correlation function output is greater than a predetermined reference. Accordingly, in embodiments, input data Y={y₀, y₁, y₂, . . . , y_{N-2}, y_{N-1} } of the LIMS algorithm is continuous correlation function output samples including signal component outputs among correlation function outputs (here, N=VP). That is, as shown in the figure, the outputs from y₁ to y_{N-2} are correlation function output results of the actual signal components and y₀ and y_{N-1} are the correlation function output results of signals near the actual signal components (before and after the signal components). All the input data {y₀, y₁, y₂, . . . , y_{N-2}, y_{N-1}} are continuous correlation function outputs. In the example of the input data, the first data and the last data of the input data are the correlation function output values of the signals near the actual signal components and the input data includes all correlation function outputs of the actual signal components. However, the first data and the last data of the input data need not always be the correlation function outputs of the signals.

According to an embodiment, as a method of eliminating the measurement error τₑ shown in FIG. 1a, a multipath signal super-resolution technique of resolving multipath signals and estimating the TOA (τ₍₁₎ of FIG. 1a) of the first arrival path signal, which is more practical as compared to the existing techniques (e.g., MUSIC, ESPRIT or Matrix Pencil), is proposed.

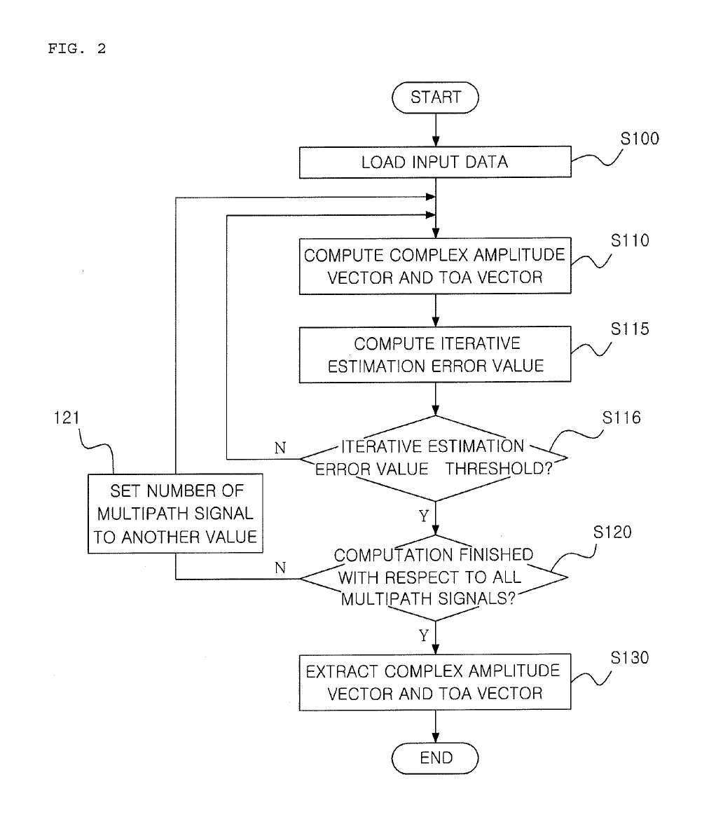

FIG. 2 is a flowchart illustrating a least-squares based iterative multipath super-resolution (LIMS) algorithm according to an embodiment.

First, input data generated using a spread-spectrum signal received through an antenna of a receiver is loaded (S100).

Next, a complex amplitude vector and a TOA vector are computed with respect to a certain number of multipath signals for each iteration order (S110), and an error value of iterative estimation is computed from the computed complex amplitude vector and the TOA vector (S115). Operations S110 and S115 are stopped if the error signal of iterative estimation becomes less than a threshold while the complex amplitude vector, the TOA vector and the error value of the iterative estimation are computed for each iteration order (S116).

Next, it is determined whether computation is finished with respect to all the multipath signals (S120). If computation of the complex amplitude vector, the TOA vector and the error value of the iterative estimation is finished with respect to all the multipath signals, the process proceeds to operation S130 of extracting the complex amplitude vector and the TOA vector of the case where the error value of the iterative estimation computed for each iteration order is minimized (S130). Otherwise, the number of multipath signals is set to another value (S121) and operations S110 to S116 are repeated.

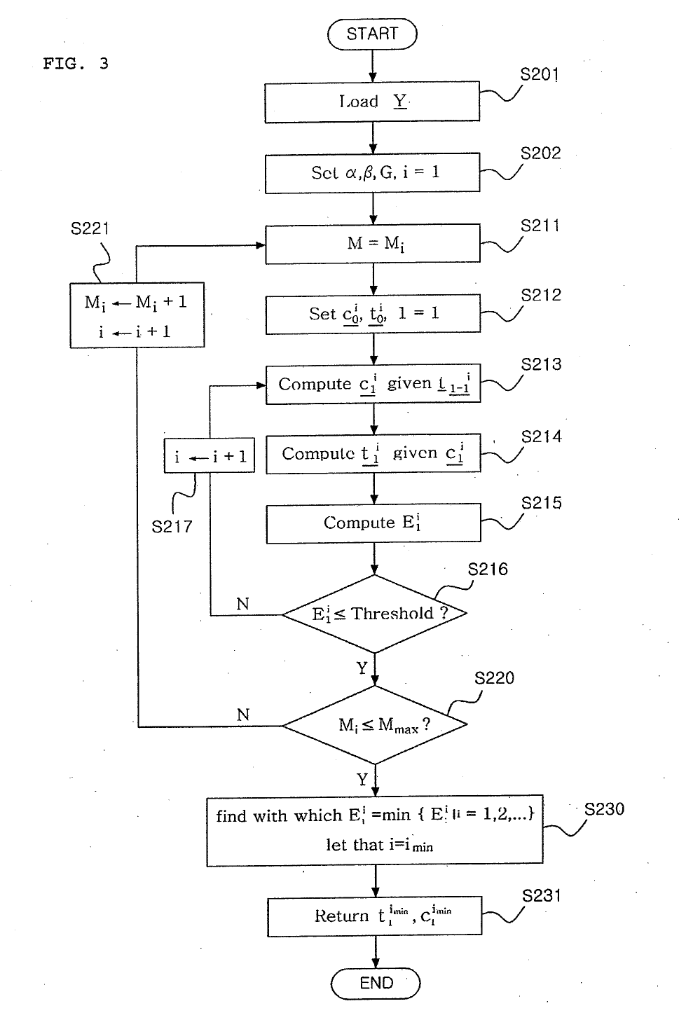

FIG. 3 is a detailed flowchart of FIG. 2.

First, output data Y of a correlation function is received (S201). LIMS parameters α, β and G are set and an index i to the hypothesis on the number of received non-negligible multipath signals is set to 1 (S202).

Next, it is assumed that M (=Mₗ) multipath signals are received according to the index i (S211). For example, first, a situation where a single path signal is received instead of multipath signals may be assumed by setting Mₗ to l, and the algorithm may be run.

Next, an iteration number l is set to 1 (l=1) and a complex amplitude vector cⁱ and a TOA vector tⁱ of the multipath signals with an iteration initial value (l=0) for the Mₗ multipath signals are assumed to be respectively c₀ⁱ and t₀ⁱ (S212). Here, c₀ⁱ and t₀ⁱ are initial value vectors for starting iterative estimation and are selected in advance in consideration of statistical characteristics of the received signals and the multipath channels.

Next, a complex amplitude vector cₗⁱ is computed based on the TOA vector computed in a previous iteration order (based on a previously assumed TOA vector t₀ⁱ in the case of a first iteration order) (S213), and a TOA vector tₗⁱ is computed based on the computed complex amplitude vector cₗⁱ (S214). An l-th iterative estimation error value Eₗⁱ is obtained from the complex amplitude vector cₗⁱ and the TOA vector tₗⁱ obtained in the current iteration order (S215). cₗⁱ may be computed by Equation 1 or 2.

cₗⁱ=(A^{H}(t_{l−1}ⁱ)G^{H}GA(t_{l−1}ⁱ))⁻¹A^{H}(t_{l−1}ⁱ)G^{H}Gy Equation 1

cₗⁱ=c_{l−1}ⁱαA^{H}(t_{l−1}ⁱ)G^{H}G(y−A(t_{l−1}ⁱ)c_{l−1}ⁱ) Equation 2

Equations 1 and 2 are both for computation of cₗⁱ, wherein Equation 1 is a direct minimization equation and Equation 2 is an iterative minimization equation. In order to compute cₗⁱ, any one of Equations 1 and 2 may be used. Equation 1 requires much computation but shows fast convergence of the iterative estimation value, whereas Equation 2 requires less computation but shows slow convergence of the iterative estimation value. tₗⁱ and Eₗⁱ may be computed by Equations 3 and 4.

tₗⁱ=t_{l−1}ⁱβRe{B^{H}(cₗⁱ,t_{l−1}ⁱ)G^{H}G(y−A(t_{l−1}ⁱ)cₗⁱ)} Equation 3

Eₗⁱ=Re{B^{H}(cₗⁱ,tₗⁱ)G^{H}G(y−A(tₗⁱ)cₗⁱ)} Equation 4

Equation 3 is an iterative minimization equation to compute tₗⁱ and Equation 4 is an equation to compute the iterative estimation error value Eₗⁱ. Parameter matrices used in Equations 1, 2, 3 and 4 may be defined by Equations 5 and 6.

[A(tₗⁱ)]_{n,m}=R(nTₛ−[tₗⁱ]ₘ) Equation 5

[B^{H}(cₗⁱ, tₗⁱ)]_{n,m}=d(R(nTₛ−[tₗⁱ]ₘ))/d([tₗⁱ]ₘ) Equation 6

In Equations 5 and 6, [·]_{n,m} denotes an element of an n-th row and an m-th column of a matrix. In Equation 5, the function R denotes a auto-correlation function of the signal, and Tₛ is a sampling period of the received signal. In Equation 6, d( )/d( ) denotes differential. The differentiation in Equation 6 indicates that the auto-correlation function R is linearized to an approximate linear function with respect to each element of the TOA vector tₗⁱ. Accordingly, the auto-correlation function R may have various forms including linear and non-linear, depending on the used signal. In particular, if the auto-correlation function R is expressed by a piece-wise linear function, accuracy of approximate linearization by the differentiation of Equation 6 is increased and more accurate multipath signal resolution performance may be obtained. For example, if a pseudonoise signal (PN code signal) is used, the auto-correlation function R is modeled into a combination of linear functions having a simple isosceles triangle shape. That is, when an apex of an isosceles triangle is a peak, a left side and a right side thereof may be expressed by linear functions, respectively. As another example, if a Binary Offset Carrier (BOC) signal of a Galileo navigation satellite is used, the auto-correlation function R may be also modeled to a combination of linear functions, although not in an isosceles triangle shape. However, even when the auto-correlation function R is theoretically modeled to a piece-wise linear function, since a bandwidth is limited in an actual environment, the auto-correlation function R is distorted and is not accurately modeled to the piece-wise linear function. In this case, if distortion is not severe, the distorted auto-correlation function may be approximated to a linear function so as to apply Equation 6 or the distorted auto-correlation function may be modeled to another non-linear function so as to apply Equation 6.

Next, the l-th iterative estimation error value Eₗⁱ is compared with a threshold and, if the l-th iterative estimation error value Eₗⁱ is greater than the threshold (S216), the value l is increased by 1 (l+1->l) (S217) and the process proceeds to operation S213 of computing the complex amplitude vector cₗⁱ. As these operations are repeated, the value Eₗⁱ becomes less than the threshold at a certain value l. At this time, the iteration order i, the iterative estimation error value Eₗⁱ, the complex amplitude vector cₗⁱ and the TOA vector tₗⁱ are stored in a memory equipped in the receiver.

Thereafter, it is determined whether the value Mₗ is equal to or greater than a maximum value Mₘₐₓ (e.g., 100). If the value Mₗ is smaller than Mₘₐₓ (S220), the value Mₗ and the value i are increased by 1 (S221) and the operations following operation S211 of assuming that Mₗ multipath signals are received are repeated. If the value Mₗ is greater than the maximum value Mₘₐₓ (S220), a smallest estimation error value is found from all the stored estimation error value Eₗⁱ (i=1, 2, 3, . . . ) and, at this time, the value i is set to iₘᵢₙ (S230). Then, cₗⁱ (=cₗ^{imin}) and tₗⁱ (=tₗ^{imin}) corresponding to i=iₘᵢₙ are finally output (S231).

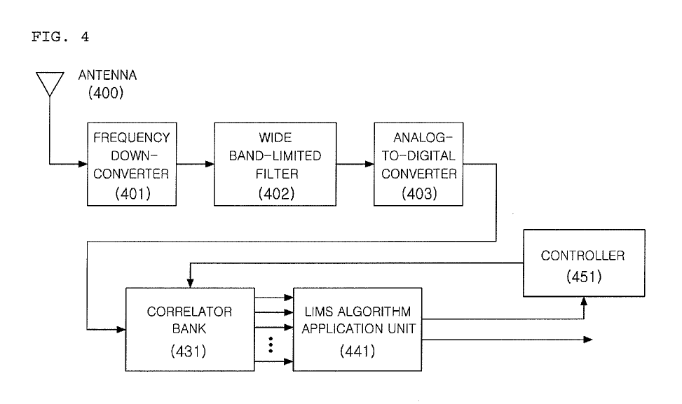

FIG. 4 is a schematic block diagram of a spread-spectrum receiver according to an embodiment.

FIG. 4 shows an example of executing a LIMS algorithm in real time. The receiver receives a radio frequency (RF) spread-spectrum signal r(t) through an antenna 400 and down-converts a high RF central frequency f_{RF} of the spread-spectrum signal into a low central frequency f_{L} using a frequency downconverter (FDC) 401.

A wide band-limited filter 402 has a wide bandwidth of 2 B_{W} and passes only a signal component having a frequency within a frequency band [f_{L}−B_{W}, f_{L}+B_{W}] near the central frequency f_{L} of the spread-spectrum signal passing through the FDC 401. The signal passing through the wide band-limited filter 402 is converted (sampled and quantized) into a digital signal through an analog-to-digital converter (ADC) 403. The digital signal is input to a correlator bank 431 including at least VP (=N) parallel correlators.

The correlator bank 431 performs correlation of N code phases which are uniformly distributed in a period of V chips under the control of a controller 451. The output {y₀, y₁, y₂, . . . , y_{N-2}, y_{N-1}} of the correlator bank 431 is input to a LIMS algorithm application unit 441 as input data.

The LIMS algorithm application unit 441 applies the LIMS algorithm described in FIG. 3 to the input data, outputs the TOA value τ₍ₗ₎ of the first arrival path signal, and outputs the amplitude cₗ^{imin} and TOA information tₗ^{imin} of all the multipath signals to the controller 451.

The controller 451 finds the minimum value min{tₗ^{imin}} from the TOA tₗ^{imin} of all the multipath signals and obtains the TOA of the first arrival path signal.

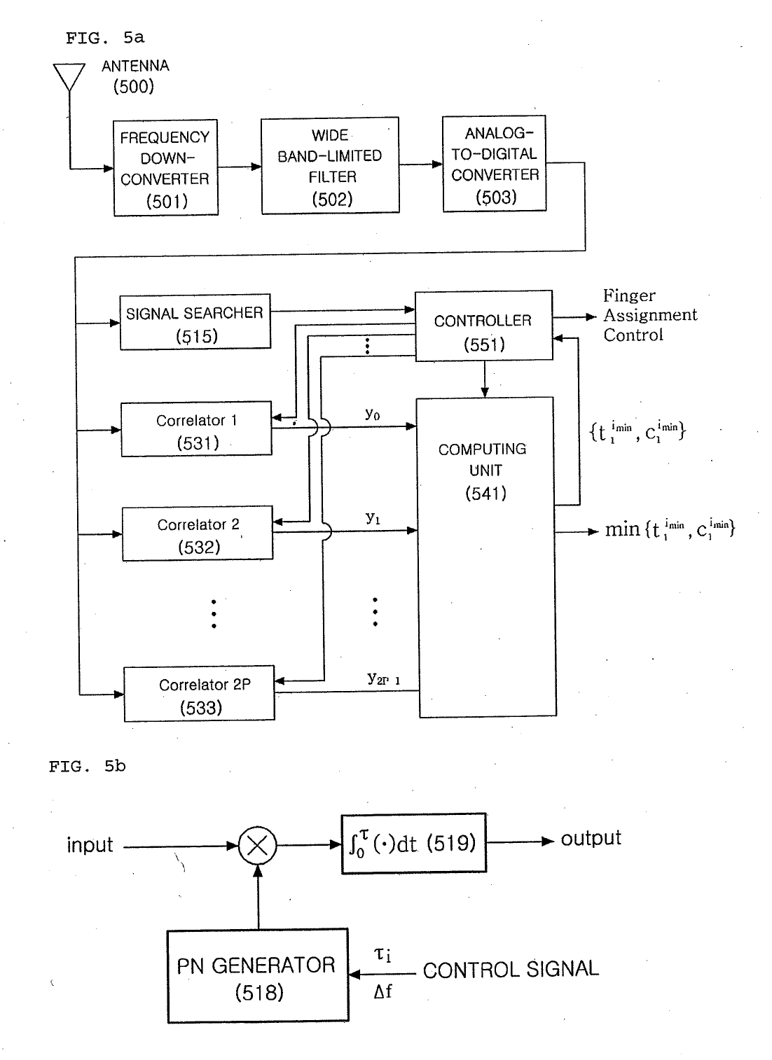

FIG. 5a shows the implementation of FIG. 3 in greater detail and shows a spread-spectrum receiver including a signal searcher 515.

The spread-spectrum receiver of FIG. 5a includes VP correlators 531, 532, 533 corresponding to VP samples within the V chips which generate sample signals from the received signals based on a sampling function for extracting P (=2) samples per chip if the multipath signal components are distributed over the V chips. If V=2 (Since a GNSS signal generally includes a plurality of multipath signals having a time delay smaller than multipath signals having a large time delay, a correlation result of a received signal has a triangular shape which extends over about two chips.), P correlators are selected so as to have a code phase earlier than a code phase of a first signal and the remaining P correlators are selected so as to have a code phase later than the code phase of the first signal.

The antenna 500, the FDC 501, the wide band-limited filter 502 and the ADC 503 perform the same functions as the blocks 300, 301, 302, 303 shown in FIG. 3. The output of the ADC 503 is input to the signal searcher 515.

The signal searcher 515 performs the code phase and frequency search of the spread-spectrum signal received from the input digital signal using serial or parallel correlators and outputs the current code phase τₖ and the frequency correction Δf the received signal to the controller 551. The signal searcher 515 performs one-dimensional (code phase) or two-dimensional (code phase and frequency error) signal search of the received signal and detects a signal. In the case of the L1 frequency signal of the GPS, since a C/A code uses a pseudonoise (PN) code having a length of 1023 chips, if the received signal is, a GPS L1 C/A signal, the code phase τₖ has a certain value in a range from 0 to 1023. In the case where the input signal is an IS-95 mobile communication signal based on CDMA, the code phase τₖ has a certain value in a range from 0 to 32768. The frequency correction Δf is a difference between the frequency of the currently received signal and the frequency generated by the receiver. In the case of the GPS or GNSS, since the intensity of the received GPS signal is low, the frequency correction Δf is accurately found from various frequency corrections by signal detection. However, in the case of a terrestrial communication system, since the intensity of the received signal is high, influence of the frequency correction Δf is very weak and thus the signal searcher 515 may not find the frequency correction Δf. The signal search using the correlator is to detect a signal with respect to various code phases τₖ₁ (k1=1, 2, 3, . . . ) and the frequency correction Δfₖ₂ (k2=1, 2, 3, . . . ).

FIG. 5b shows an implementation of a signal searcher using a general correlator.

A PN generator 518 generates a PN signal having a code phase τₖ₁ and a frequency correction Δfₖ₂ according to control signals τₖ₁ and Δfₖ₂ of the controller 551.

The PN signal is multiplied by an input signal, and the multiplied signal is accumulated in an accumulator 519 for T seconds, thereby generating a final output for hypothesis [k1, k2].

The control signals τₖ₁ and Δfₖ₂ of the controller 551 delivers the new hypothesis [k1, k2] every T seconds and the output of the accumulator 519 is obtained through the signal searcher 515 with respect to all k1 values and all k2 values.

The controller 551 finds one frequency correction Δfₖ₂, in which the output of the accumulator 519 is highest, from all output results of the accumulator 519 and finds all code phases τ_{K1} (that is, K1 is a value equal to or greater than 1) in which the output of the accumulator 519 is higher than an output generated by noise based on the frequency correction Δfₖ₂.

The controller 551 sets VP sub-code phases uniformly distributed in the code phase period of V1 to V2 and sends control signals including VP sub-code phases to the VP correlators 531, 532, 533, if a continuous code phase window including all code phases τ_{K1} in which the output of the accumulator 519 is higher than an output generated by noise extends over a total of V chip periods (that is, a region from code phases V1 to V2). In the case of the GPS (GNSS) receiver, the controller 551 sends the control signals including the frequency correction Δfₖ₂ detected by the signal search 515 to the VP correlators 531, 532, 533. The VP (=N) correlators 531, 532, 533 output and send the continuous correlation function output samples Y={y₀, y₁, y₂, . . . , y_{N-2}, y_{N-1}} to a computing unit 541 for performing the LIMS algorithm with respect to the continuous correlation function output samples, as shown in FIG. 1b.

The output of the computing unit 541 includes the output values (the amplitude cₗ^{imin} and the TOA information tₗ^{imin} of all the multipath signals) of operation S231 of FIG. 2.

The output values are input to the controller 551. The controller 551 sets the results cₗ^{imin} and tₗ^{imin} at a time t=t0 obtained by the computing unit 541 as an initial value for applying the LIMS algorithm to a signal received at a time t=t0+Δt (Δt is a small value) just after t0 and sends the results to the computing unit 541. The controller 551 may generate control signals to be applied to an algorithm for assigning a finger of a rake receiver based on the output of the computing unit 541.

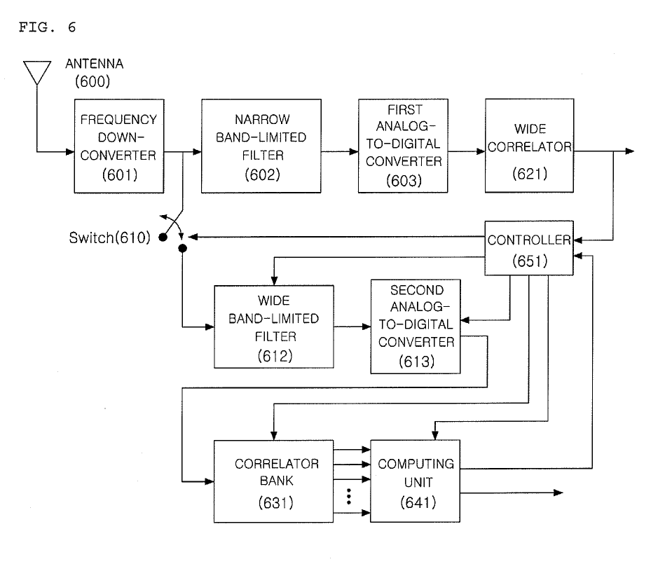

FIG. 6 shows the structure of a receiver in which a LIMS technique according to an embodiment is used for signal tracking in addition to a wide correlator.

An antenna 600 and an FDC 601 perform the same functions as the antenna 400 and the FDC 401 of FIG. 4. A narrow band-limited filter 602 passes a signal within a narrow frequency band, unlike the wide band-limited filter 402. Accordingly, if the narrow band-limited filter 602 is used, the peak of the output of the correlation function does not have a sharp shape but has a smoothed curve shape.

A first analog-to-digital converter (ADC) 603 samples the output signal of the narrow band-limited filter 602 to two times a chip rate of a currently used pseudonoise signal, converts the output signal to a digital signal, and sends the digital signal to a DLL-based wide correlator 621.

The wide correlator 621 tracks a code phase in real time based on the digital signal. For example, the wide correlator 621 compares the correlation function results of an early correlator of ½ chip or more and a late correlator of ½ chip or more so as to track the code phase in real time. In general, the wide correlator 621 requires a sampling rate of 2 per chip, but LIMS performance is improved as the sampling rate is increased. In contrast, the wide correlator 621 has excellent first arrival path signal tracking performance in a single path channel environment with low complexity, but has poor performance in a multipath channel environment. Accordingly, the controller 651 observes the operation of the wide correlator 621 and closes a switch 610 so as to enable the LIMS algorithm with excellent multipath signal resolution and TOA extraction performance of the first arrival path signal to be used in the multipath channel environment with high complexity, if a current channel environment is a multipath channel environment, such as an environment in which an absolute value of a difference between the correlation function values of the early correlator of ½ chip or more and the late correlator of ½ chip or more is greater than a first switching threshold is maintained for a specific time or is changed greatly with time (e.g., when the difference between the correlation function values is changed at a first switching rate or more).

Alternatively, in the case where the LIMS algorithm is operated with a predetermined period, in the case where the controller 651 receives a particular key input of a user or a request of a higher-level program and operates the LIMS algorithm according to the request, in the case where the intensity of the received signal becomes less than a threshold (signal intensity threshold) and influence of noise is relatively increased such that it is difficult to stably track the signal using the difference between the correlation function results of the early correlator of ½ chip or more and the late correlator of ½ chip or more, or in the case where the intensity of the received signal is significantly changed (when a variation in signal intensity is greater than a variation threshold), the controller 651 may close the switch 610.

The signal intensity threshold, the variation threshold, the first switching threshold or the first switching rate is arbitrarily set as necessary.

At this time, since the LIMS algorithm may require a higher sampling rate than the wide correlator 621, a separate ADC 613 is used. In order to distinguish between the two ADCs shown in FIG. 6, the ADC 603 used together with the wide correlator 621 is defined as a first ADC and the ADC 613 used together with the correlator bank 631 is defined as a second ADC.

The input of the switch 610 is the output of the FDC 601, the signal passing through the switch 610 is input to the wide band-limited filter 612, and the output of the wide band-limited filter 612 is sent to the second ADC 613. The blocks 631 and 641 of FIG. 6 are the same as the blocks 331 and 341 in FIG. 3. The operation of the controller 651 when the switch 610 is closed is the same as the operation of the block 351 in FIG. 3. When the controller 651 generates the control signal for closing the switch 610, the blocks 612, 613, 631 and 641 may operate simultaneously by the control signal of the controller 651.

Since the LIMS algorithm is based on a mathematical model of a first order linear equation of the correlation function output, performance is improved as the correlation function output is closer to the first order linear function. The use of the wide band-limited filter 612 enables the correlation function output to have a shape close to an isosceles triangle. However, the correlation function output needs not necessarily be the first order linear function in order to use the LIMS algorithm. The wide band-limited filter 612 may not be used. In this case, the second ADC 613 receives the output of the narrow band-limited filter 602 through the switch 610. That is, the output of the narrow band-limited filter 602 is connected to the switch 610 and, when the switch 610 is closed by the control signal of the controller 651, the received signal passing through the switch 610 is input to the second ADC 613.

The rake receiver used in the spread-spectrum receiver includes a plurality of parallel fingers and each finger continuously tracks each signal component using a wide correlator. According to the above-described embodiment, a multipath channel is resolved so as to improve performance of the rake receiver.

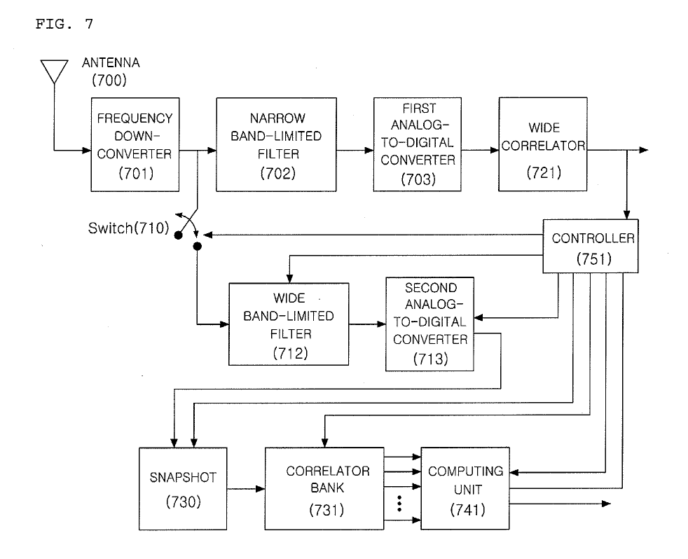

FIG. 7 is a diagram showing an embodiment in which a snapshot 730 is added to FIG. 6.

FIG. 6 and FIG. 7 are equal to each other, except for the block 730. The blocks 700, 701, 702, 703, 713, 721, 731, 741 and 751 are equal to the blocks 600, 601, 602, 603, 613, 621, 631, 641 and 651, respectively.

The snapshot 730 sends the control signal for the controller 751 to close the switch 710 and receives the control signal from the controller 751. The snapshot 730 begins to store the output of the ADC 713 according to the control signal of the controller 751 and stores the continuous output of the second ADC 713 for a specific time according to the control signal of the controller 751. The signal stored by the snapshot 730 is sent to the correlator bank 731 and is used to compute the TOA value τ₍ₗ₎ of the first arrival path signal through the LIMS algorithm. FIG. 6 shows a continuous signal tracking method using the wide correlator and the LIMS algorithm, and FIG. 7 shows a method for extracting only the first arrival path signal at a specific time.

In FIG. 7, the wide band-limited filter 712 may not be used. In this case, the ADC 713 receives the output of the narrow band-limited filter 702 through the switch 710. That is, the output of the narrow band-limited filter 702 is connected to the switch 710 and, when the switch 710 is closed according to the control signal of the controller 751, the received signal passing through the switch 710 is input to the second ADC 713.

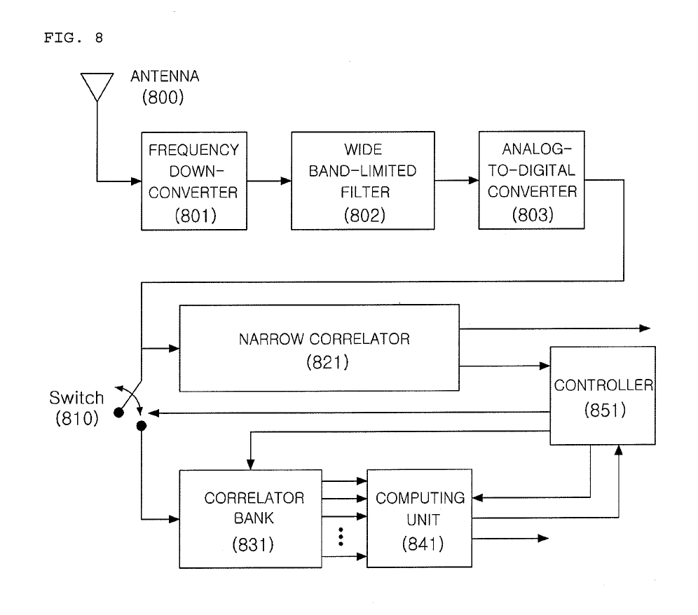

FIG. 8 shows the structure of a receiver in which the LIMS technique according to an embodiment is used for signal tracking in addition to a narrow correlator.

In FIG. 8, an antenna 800, an FDC 801, a wide band-limited filter 802 and a first ADC 803 have the same functions as the antenna 400, the FDC 401, the wide band-limited filter 402 and the ADC 403 of FIG. 4, respectively. And, the blocks 831 and 841 have the same functions as the blocks 331 and 341 of FIG. 3, respectively. The digital signal obtained by the first ADC 803 is sent to a narrow correlator 821.

The narrow correlator 821 tracks a code phase in real time using an early correlator of less than ½ chip and a late correlator of less than ½ chip, unlike the wide correlator 621. For example, the narrow correlator 821 compares correlation function results of an early correlator of 1/10 chip and a late correlator of 1/10 chip so as to track the code phase in real time.

A controller 851 controls a switch 810 according to an output of the narrow correlator 821. For example, in the case where it is determined that a current channel environment is a multipath channel environment, that is, in the case where the LIMS algorithm is operated with a predetermined period, in the case where the controller 851 receives a particular key input of a user or a request of a higher-level program and operates the LIMS algorithm according to the request, in the case where the intensity of the received signal becomes less than a threshold (signal intensity threshold) and influence of noise is relatively increased such that it is difficult to stably track the signal using a difference between the correlation function results of the early correlator of 1/10 chip and the late correlator of 1/10 chip, in the case where the intensity of the received signal is significantly changed (when a variation in signal intensity is greater than a variation threshold), in the case where a situation in which an absolute value of a difference between correlation function values of the early correlator of 1/10 chip and the late correlator of 1/10 chip is greater than a second switching threshold is maintained for a specific time, or in the case where the absolute value of the difference between the correlation function values is significantly changed (when the difference between the correlation function values is changed at a second switching rate or more), the controller 851 outputs a control signal to the switch 810 so as to close the switch 810 such that the output of the first ADC 803 is sent to the correlator bank 831 so as to measure a more accurate TOA value τ₍ₗ₎ of a first arrival path signal through the LIMS algorithm. The signal intensity threshold, the variation threshold, the second switching threshold or the second switching rate is arbitrarily set as necessary. At this time, the controller 851 may send control signals to the correlator bank 831 and a computing unit 841 so as to begin the LIMS algorithm.

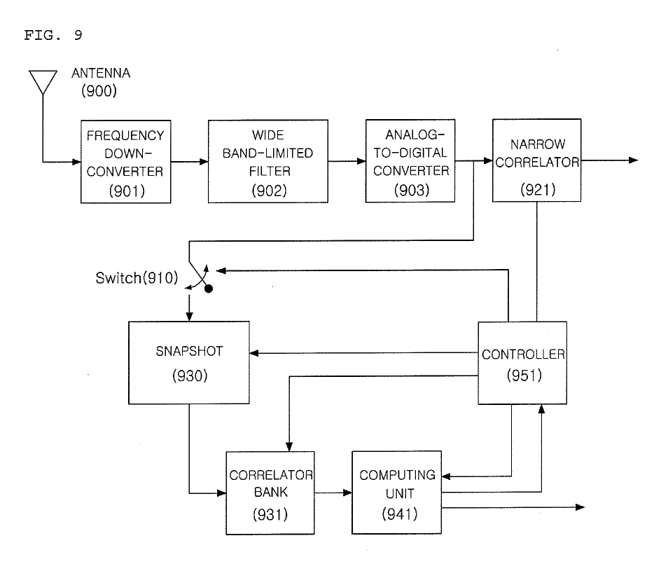

FIG. 9 is a diagram showing an embodiment in which a snapshot 930 is added to FIG. 8.

In FIG. 9, unlike the real-time LIMS algorithm operating method shown in FIG. 8, the LIMS technique is used offline similarly to FIG. 7.

The snapshot 930 serves to store digital data input through a switch 910 closed by the control signal of the controller 951. Snapshot data stored in the snapshot 930 is sent to the correlator bank 931 by the control signal of the controller 951 so as to apply the LIMS algorithm. FIG. 8 shows a method of performing continuous signal tracking, resolving multipath signals and measuring TOA of a first arrival path signal using the LIMS algorithm and the narrow correlator, and FIG. 9 shows a method of resolving multipath signals at a specific instant and extracting and outputting TOA of a first arrival path signal.

A GPS (or GNSS) receiver using the LIMS technique according to the embodiment can more accurately measure a distance between a satellite and a receiver by detecting an accurate first arrival path signal. Thus, position measurement performance of the GPS (or GNSS) receiver is remarkably improved in a region in which the number of paths is large, such as a city area. Since distance measurement accuracy improvement is achieved not only in GPS or GNSS but also in all communications and positioning systems using a spread-spectrum signal, the LIMS technique of the embodiment may be variously used in receivers.

The embodiment may be executed by software. Specifically, a program for executing, on a computer, a multipath signal super-resolution method of a spread-spectrum signal receiver according to the embodiment may be recorded on a computer-readable recording medium. When the embodiment is executed by software, the configuration elements of the embodiment may be code segments for executing a necessary operation. The program or code segments may be stored in a processor-readable medium or transmitted by a computer data signal combined with carrier waves through a transmission medium or a communication network.

A computer-readable recording medium includes all recording devices for storing data readable by a computer system. Examples of the computer-readable recording device includes a ROM, a RAM, a CD-ROM, a DVD±ROM, a DVD-RAM, a magnetic tape, a floppy disk, a hard disk, and an optical data storage. The computer-readable recording medium is provided to computer devices connected over a network such that the computer-readable code may be stored and executed.

According to the embodiments of the present invention, a receiver accurately detects a first arrival signal and measures TOA from the first arrival signal such that distance and position measurement accuracy of the receiver is significantly improved. Since each finger of the rake receiver accurately finds and tracks an actual signal component which is not a distorted signal component generated due to interference between multipath signals, performance of the rake receiver is also improved.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. A multipath signal super-resolution method of a spread-spectrum signal receiver, comprising:
computing a complex amplitude vector and a Time of Arrival (TOA) vector with respect to a predetermined number of multipath signals for each iteration order until an iterative estimation error value becomes equal to or less than a threshold and computing the iterative estimation error value from the complex amplitude vector and the TOA vector; and
extracting a complex amplitude vector and a TOA vector of the case where the iterative estimation error value computed for each iteration order is minimized.

2. The multipath signal super-resolution method according to claim 1, wherein the computing of the iterative estimation error signal includes converting a spread-spectrum signal received through an antenna into a digital sample and utilizing an output obtained by inputting the digital sample to a correlation function as input data for computing the complex amplitude vector and the TOA vector.

3. The multipath signal super-resolution method according to claim 1, wherein, in the computing of the iterative estimation error value, either a direct minimization equation or an iterative minimization equation is used in order to compute the complex amplitude vector, and an iterative minimization equation is used in order to compute the TOA vector.

4. The multipath signal super-resolution method according to claim 1, wherein the computing of the iterative estimation error value includes: setting the number of multipath signals for each iteration order and computing the complex amplitude vector based on the TOA vector computed in a previous iteration order with respect to the set number of multipath signals; and computing the TOA vector of a current iteration order based on the complex amplitude vector.

5. A computer-readable recording medium having recorded thereon a program for executing the method according to claim 1 on a computer system.

6. A spread-spectrum signal receiver comprising:
a wide band-limited filter configured to pass only a predetermined band of a spread-spectrum signal;
an analog-to-digital converter configured to convert the spread-spectrum signal passing through the wide band-limited filter into a digital signal;
a correlator bank configured to receive the digital signal, to perform correlation with respect to a plurality of code phases distributed in a plurality of chip periods, and to generate input data; and
a computing unit configured to compute a complex amplitude vector and a Time of Arrival (TOA) vector with respect to a predetermined number of multipath signals using the input data for each iteration order, to compute the iterative estimation error value from the complex amplitude vector and the TOA vector, and to extract a complex amplitude vector and a TOA vector of the case where the iterative estimation error value computed for each iteration order is minimized.

7. The spread-spectrum signal receiver according to claim 6, wherein the computing unit sets the number of multipath signals for each iteration order, computes the complex amplitude vector based on the TOA vector computed in a previous iteration order with respect to the set number of multipath signals, and computes the TOA vector of a current iteration order based on the complex amplitude vector.

8. The spread-spectrum signal receiver according to claim 6, further comprising: a signal searcher configured to perform signal search using a correlator with respect to the digital signal and to compute a code phase and a frequency correction of the spread-spectrum signal; and a controller configured to control the correlator bank according to a control signal including at least one of the code phase or the frequency correction.

9. The spread-spectrum signal receiver according to claim 6, further comprising: a narrow correlator configured to receive the digital signal, to compare correlation function results of an early correlator and a late correlator, and to track the code phase of the spread-spectrum signal; a switch configured to send the digital signal to any one of the correlator bank or the narrow correlator; and a controller configured to control the switch according to an output value of the narrow correlator.

10. The spread-spectrum signal receiver according to claim 9, wherein the narrow correlator uses an early correlator of less than ½ chip and a late correlator of less than ½ chip.

11. The spread-spectrum signal receiver according to claim 9, wherein, if a predetermined period has reached, if a key input of a user is input, if a higher-level program request is input, if the intensity of the spread-spectrum signal becomes less than a signal intensity threshold, if a variation in the spread-spectrum signal is greater than a variation threshold, if a state in which a difference between correlation function values of an early correlator of less than ½ chip and a late correlator of less than ½ chip is greater than a second switching threshold is maintained for a predetermined time, or if the difference between the correlation function values is changed at a second switching rate or more, the controller controls the switch to be closed.

12. The spread-spectrum signal receiver according to claim 9, further comprising a snapshot configured to store the digital signal and to send the stored digital signal to the correlator bank under the control of the controller.

13. A spread-spectrum signal receiver comprising:
a narrow band-limited filter configured to pass only a first band of a spread-spectrum signal;
a first analog-to-digital converter configured to convert the spread-spectrum signal passing through the narrow band-limited filter into a first digital signal;
a wide correlator configured to receive the first digital signal, to compare correlation function results of an early correlator and a late correlator, and to track a code phase of the spread-spectrum signal;
a wide band-limited filter configured to pass only a second band of the spread-spectrum signal;
a switch configured to send the spread-spectrum signal to any one of the narrow band-limited filter or the wide band-limited filter;
a controller configured to control the switch according to an output value of the wide correlator;
a second analog-to-digital converter configured to convert the spread-spectrum signal passing through the wide band-limited filter into a second digital signal;
a correlator bank configured to receive the second digital signal, to perform correlation with respect to a plurality of code phases distributed in a plurality of chip periods, and to generate input data; and
a computing unit configured to compute a complex amplitude vector and a Time of Arrival (TOA) vector with respect to a predetermined number of multipath signals using the input data for each iteration order, to compute the iterative estimation error value from the complex amplitude vector and the TOA vector, and to extract a complex amplitude vector and a TOA vector of the case where the iterative estimation error value computed for each iteration order is minimized.

14. The spread-spectrum signal receiver according to claim 13, wherein the wide correlator uses an early correlator of ½ chip or more and a late correlator of ½ chip or more.

15. The spread-spectrum signal receiver according to claim 13, wherein, if a predetermined period has reached, if a key input of a user is input, if a higher-level program request is input, if the intensity of the spread-spectrum signal becomes less than a signal intensity threshold, if a variation in the spread-spectrum signal is greater than a variation threshold, if a state in which a difference between correlation function values of an early correlator of ½ chip or more and a late correlator of ½ chip or more is greater than a first switching threshold is maintained for a predetermined time, or if the difference between the correlation function values is changed at a first switching rate or more, the controller controls the switch to be closed.

16. The spread-spectrum signal receiver according to claim 13, further comprising a snapshot configured to store the second digital signal and to send the stored second digital signal to the correlator bank under the control of the controller.

17. A spread-spectrum signal receiver comprising:
a narrow band-limited filter configured to pass only a first band of a spread-spectrum signal;
a first analog-to-digital converter configured to convert the spread-spectrum signal passing through the narrow band-limited filter into a first digital signal;
a wide correlator configured to receive the first digital signal, to compare correlation function results of an early correlator and a late correlator, and to track a code phase of the spread-spectrum signal;
a second analog-to-digital converter configured to convert the spread-spectrum signal passing through the narrow band-limited filter into a second digital signal;
a switch configured to send the spread-spectrum signal passing the narrow band-limited filter to any one of the first analog-to-digital converter or the second analog-to-digital converter;
a controller configured to control the switch according to an output value of the wide correlator;
a correlator bank configured to receive the second digital signal, to perform correlation with respect to a plurality of code phases distributed in a plurality of chip periods, and to generate input data; and
a computing unit configured to compute a complex amplitude vector and a Time of Arrival (TOA) vector with respect to a predetermined number of multipath signals using the input data for each iteration order, to compute the iterative estimation error value from the complex amplitude vector and the TOA vector, and to extract a complex amplitude vector and a TOA vector of the case where the iterative estimation error value computed for each iteration order is minimized.

18. The spread-spectrum signal receiver according to claim 17, wherein the computing unit uses a least-squares based iterative multipath super-resolution (LIMS) algorithm.
